(19) United States
(12) Patent Application Publication
(10) Pub. No.: US 2007/0030793 A1
(43) Pub. Date: Feb. 8, 2007

(54) Method and radiation source driving device for controlling radiation power

(76) Inventors: Gerard Elise Noel Schreurs, Eindhoven (NL); James Joseph Anthony McCormack, Eindhoven (NL); Antonia Cornelia Van Rens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,627

(22) PCT Filed: May 13, 2004
(86) PCT No.: PCT/IB04/50676

§ 371 Date: Nov. 17, 2005

(30) Foreign Application Priority Data
May 20, 2003 (EP) 03101426.9

(51) Int. Cl. G11B 7/24

(52) U.S. Cl. 369/275.4

(57) ABSTRACT

The invention pertains to a method for controlling radiation power of a radiation source (26), comprising the steps of a) driving the radiation source (26) in a first mode comprising the substeps of a1) determining a threshold current _{(Ithr)} at which the radiation source (26) begins to radiate, a2) measuring the radiation power emitted by the radiation source (26), a3) driving the radiation source (26) with the threshold current (Iₜhᵣ) increased with the a delta current _{(Idelta)} for obtaining a predetermined radiation power Pᵣ1, wherein the delta current _{(Idelta)} is calculated by subtracting the measured radiation power (Pₘ) from the predetermined radiation power Pᵣ1, b) driving the radiation source (26) in a second mode comprising the substeps of b1) determining the threshold current _{(Ithr)}, and b2) driving the radiation source (26) with the threshold current (Ithᵣ) increased with the delta current _{(Idelta)} for obtaining the predetermined radiation power Pᵣt, wherein the delta current _{(Idelta)} is calculated from the threshold current (Iₜhᵣ) by using a function F which is a model for the relation between the threshold current (Iₜhᵣ) and the delta current _{(Idelta)} and the radiation power. The relation between the delta current _{(Idelta)} and the threshold current (Ithr) however changes during the lifetime of the radiation source. Therefore the method according to the invention further comprises the step of c) calibrating the function F, comprising the substeps of c1) determining the radiation power and the delta current _{(Idelta)} at at least two different threshold currents (Iₜhᵣ) when the radiation source (26) is driven in the first mode, and c2) updating at least one parameter of the function F by using the measurements in substep c1.

The invention pertains to a method for controlling radiation power of a radiation source, comprising the steps of

a) driving the radiation source in a first mode comprising the substeps of
a1) determining a threshold current at which the radiation source begins to radiate,
a2) measuring the radiation power emitted by the radiation source,
a3) driving the radiation source with the threshold current increased with the a delta current for obtaining a predetermined radiation power Pᵣ₁, wherein the delta current is calculated by subtracting the measured radiation power from the predetermined radiation power Pᵣ₁,

b) driving the radiation source in a second mode comprising the substeps of
b1) determining the threshold current, and
b2) driving the radiation source with the threshold current increased with the a delta current for obtaining the predetermined radiation power Pᵣ₁, wherein the delta current is calculated from the threshold current by using a function F which is a model for the relation between the threshold current and the delta current and the radiation power.

The invention also pertains to a radiation source driving device for controlling a radiation power of a radiation source in an information reproducing system for reproducing information on an information carrier, comprising

radiation power measurement means for measuring a radiation power of the radiation source,

addition means for outputting a total current by adding a threshold current and a delta current and thereby obtaining a predetermined radiation power Pᵣ₁,

threshold current determining means for determining and outputting the threshold current at which the radiation source begins to radiate, wherein the measured radiation power is used to determine the threshold current,

delta current determining means for determining and outputting the delta current wherein the value of the delta current is determined such that the radiation power is substantially equal to a predetermined radiation power Pᵣ₁, comprising
an online delta current generator for generating an online delta current which is determined by subtracting the measured radiation power from the predetermined radiation power Pᵣ₁,
a estimated delta current generator for generating an estimated delta current which is calculated from the threshold current by using a function F which is a model for the relation between the threshold current and the delta current and the radiation power,
delta current outputting means for outputting the delta current, wherein the online delta current is outputted when the radiation power is measured and the estimated delta current is outputted when the radiation power is not measured.

The invention further pertains to an information reproducing device for reproducing information on an information carrier comprising the radiation source driving device.

During writing on an optical disc it is very important to control the writing power precisely since the writing quality is extremely sensitive to the writing power. However, with increasing writing speeds it is very difficult or impossible to measure the write power during the very short write pulse if a pulse train is used as a write strategy. Usually, when reading information from a disc, the radiation power is more easily measured. In stead of measuring the radiation power at both read and write level, only the radiation power is measured in read level and controlled by adjusting the threshold current. However, the efficiency of the radiation source is changing with temperature. The change in temperature and thus the change in efficiency has an effect on the threshold current of the radiation source. From the change in the threshold current the efficiency of the radiation source can be predicted. A correction factor can be determined which is used to determine a delta current from the threshold current, wherein the delta current is the current at which a predetermined radiation power is emitted by the radiation source. When applying a write strategy wherein the radiation power is higher than then the power at read level and where it is difficult to measure the radiation power, the correction factor can be used to predict the delta current needed for obtaining a predetermined radiation power.

From European Patent application 1169759 a control circuit for a radiation source is known which comprises means for generating an error signal which is indicative for a difference between a measured average value of the output power of the radiation source and a desired average value of the output power of the radiation source. The circuit further comprises combining means for generating a control signal for the radiation source in response to said error signal and to an information signal for modulating the radiation source. The combining means comprise first means for modifying the information signal by a multiplicative factor γ which is dependent on the error signal, and second means for modifying the information signal by an additive factor σ which is dependent on the error signal. The additive factor σ is linearly dependent on the error signal, while the multiplicative factor γ is computed from σ according to the function:

$$γ = k σ + b \\ wherein \\ k = a \frac{{γ}_{0}}{{σ}_{0}} and b = {γ}_{0} \qquad ( 1 )$$

Therein γ₀ and σ₀ respectively are the values of γ and σ at a reference temperature. The used function (1) to compute γ from σ is fixed, but it seems that the actual relation between the multiplicative factor γ and the additive factor σ is not fixed. The factor k changes during the lifetime of the radiation source. The multiplicative factor γ can deviate during the lifetime of the radiation source from the correct one. The radiation source then radiates a faulty radiation power.

It is a purpose of the invention to provide a method for controlling radiation power of a radiation source which is capable of attaining a radiation power even under changing conditions such as temperature changes.

It is a further purpose of the invention to provide a radiation source driving device which is capable of attaining a radiation power even under changing conditions such as temperature changes.

It is also a purpose of the invention to provide an information reproducing device comprising such a radiation source driving device.

According to the invention the method for controlling radiation power of a radiation source further comprises the step of

c) calibrating the function F, comprising the substeps of
c1) determining the radiation power and the delta current at at least two different threshold currents when the radiation source is driven in the first mode, and
c2) updating at least one parameter of the function F by using the measurements in substep c1.

When the function F is defined by one parameter, then it is possible to update the parameter of that function by determining two points of the function F. If the calibration is performed regularly then the radiation power can be controlled precise by first establishing the threshold current and subsequently calculate the required delta current to obtain a certain radiation power. If the function F is characterized by more than one parameter, then in substep 1 the radiation power and delta current are measured at more than two threshold currents.

In a embodiment of the method according to the invention the current to the radiation source is selectively driven in a first mode and in a second mode, wherein the radiation power can be measured when the radiation source is driven in the first mode and wherein the radiation power can not be measured when the radiation source is driven in the second mode, wherein step c of calibrating the function F is performed during a period wherein the radiation source is driven in the first mode.

For instance, when writing on an optical disc with a pulse train strategy it is impossible to measure the write power level because the pulses are too short. However, when writing with a block strategy it is still possible to measure the write level even at high speeds. A block strategy is a writing strategy involving long write pulses. Especially when writing long marks on an information carrier it is relatively easy to measure the power level of the emitted radiation. In the block strategy writing mode it is therefore possible to calibrate the function F. Because of environmental changes such as temperature changes, the measured write power will be different from the desired write power and the function F can be tuned until both are equal. Since the function F is only determined by radiation source behavior, it is still valid for the pulse train strategy. By tuning the function F in a block strategy mode, the function F is tuned for every strategy used. In the case of the method being used in an optical drive such as a DVD+RW drive, each time a disc which requires a block strategy is inserted, the function F can be calibrated.

In a further embodiment the first mode is a mode wherein the current to the radiation source comprises a pulse which has a duration long enough to measure the radiation power and wherein the second mode is a mode wherein the current to the radiation source comprises a train of short pulses.

In an embodiment the function F is defined by a model describing the change in delta current as a function of the change in threshold current at the predetermined radiation power Pᵣ₁:

$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a \qquad ( 2 )$$

wherein I_{THR-1} is a first threshold current, I_{THR-2} is a second threshold current, I_{DELTA-1} is a first delta current, I_{DELTA-2} is a second delta current and a is a parameter and wherein the function F is updated by updating the parameter a.

This model is a relatively simple model which describes the behavior of a radiation source such as a semiconductor laser.

In an other embodiment of the method wherein the radiation power and delta current are measured at more than two threshold currents, the function F is defined by a model describing the change in delta current as a function of the change in threshold current at a predetermined level of the radiation power Pr:

$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a + b \qquad ( 3 )$$

wherein I_{THR-1} is a first threshold current, I_{THR-2} is a second threshold current, I_{DELTA-1} is a first delta current, I_{DELTA-2} is a second delta current and a and b are parameters and wherein the function F is updated by updating the parameters a and b.

A relative easy way for changing the threshold current is changing the temperature of the radiation source. The threshold current of a radiation source such as a semiconductor laser is dependent on the temperature of the laser. The temperature of the radiation source can be increased for instance, by activating the radiation source for a longer period.

According to the invention radiation source driving device further comprises calibration means for updating at least one parameter of the function F, wherein the delta current, the threshold current and the measured radiation power are fed to the calibration means and wherein the radiation power and the delta current are determined at at least two different threshold currents and are subsequently used to update the at least one parameter.

In an embodiment of the radiation source driving device the radiation source current generator is able to drive the radiation source in a first mode and in a second mode, wherein the radiation power measurement means are able to measure the radiation power when the radiation source is driven in the first mode and wherein the radiation power measurement means are not able to measure the radiation power when the radiation source is driven in the second mode, wherein the calibration means are arranged to calibrate the function F during a period wherein the radiation source is driven in the first mode.

In a variant of the previous embodiment the first mode is a mode wherein the current to the radiation source comprises a pulse which has a duration long enough to measure the radiation power and wherein the second mode is a mode wherein the current to the radiation source comprises a train of short pulses.

In a further embodiment of the radiation source driving device the function F is defined by a model describing the change in delta current as a function of the change in threshold current at the predetermined radiation power Pᵣ₁:

$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a \qquad ( 4 )$$

wherein I_{THR-1} is a first threshold current, I_{THR-2} is a second threshold current, I_{DELTA-1} is a first delta current, I_{DELTA-2} is a second delta current and a is a parameter and wherein the calibration means are adopted to update the function F by updating the parameter a.

In a still further embodiment of the radiation source driving device the calibration means are arranged for measuring the radiation power and the delta current at more than two different threshold currents.

In a more specific embodiment of the previous embodiment the function F is defined by a model describing the change in delta current as a function of the change in threshold current at a predetermined level of the radiation power Pr:

$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a + b \qquad ( 5 )$$

wherein I_{THR-1} is a first threshold current, I_{THR-2} is a second threshold current, I_{DELTA-1} is a first delta current, I_{DELTA-2} is a second delta current and a and b are parameters and wherein the calibration means are adopted to update the function F by updating the parameters a and b.

According to the invention the information reproducing device for reproducing information on an information carrier comprises

the radiation source driving device according to the invention,

a radiation source which is driven by the radiation source driving device,

means for mapping radiation emitted by the radiation source at a spot at the information carrier,

means for causing a relative displacement between the spot and the information carrier.

The information reproducing device according to the invention has the advantage that the radiation power of the radiation source is controlled accurately, even when the radiation source is driven in a mode wherein it is impossible or difficult to measure the radiation power.

These and other aspects of the invention are described in more detail with reference to the figures. Therein

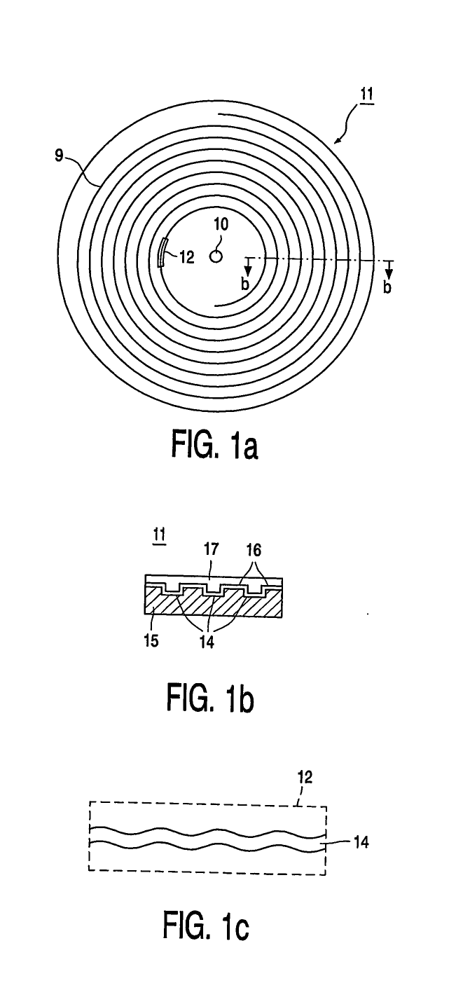

FIG. 1 1a shows a disc shaped information carrier,

FIG. 1b shows a cross-section taken of the information carrier,

FIG. 1c shows an example of a wobble of the track,

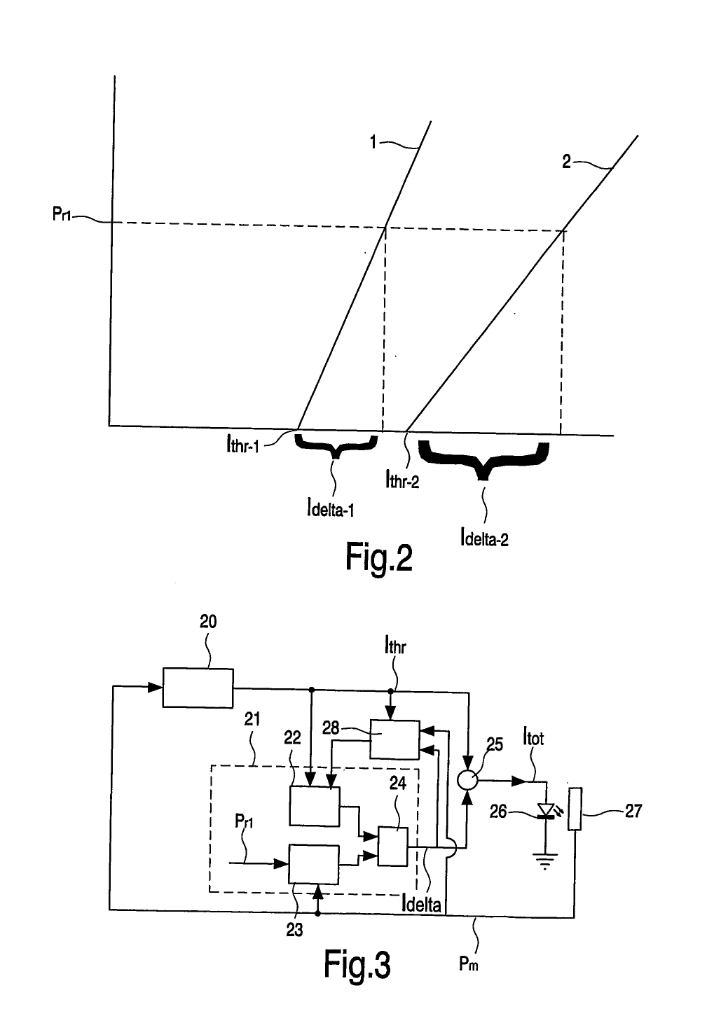

FIG. 2 shows two curves for the relation between the threshold current and the delta current in a radiation source,

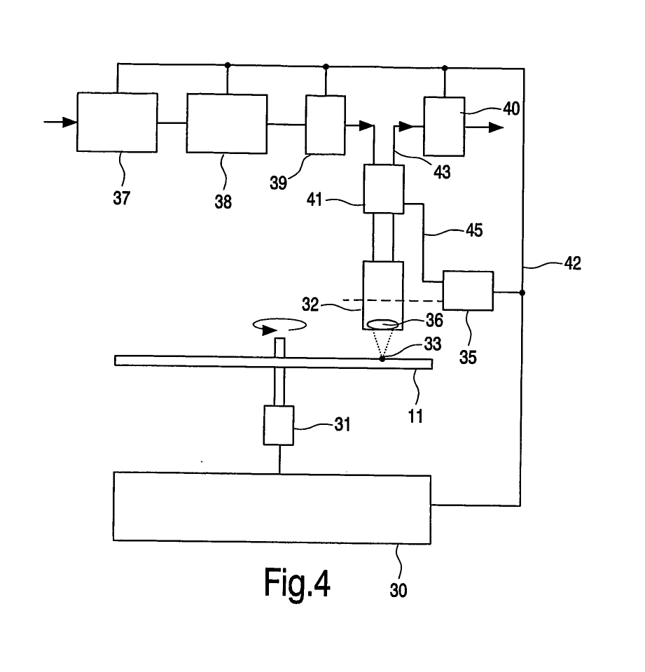

FIG. 3 shows an embodiment of the radiation source driving device, and

FIG. 4 shows an embodiment of the information reproducing device.

An example of an information carrier 11 from which the information reproducing system reproduces information is shown in FIG. 1a. The disc-shaped information carrier 11 comprises a track 9 and a central hole 10. The track 9 is arranged in accordance with a spiral pattern of turns constituting substantially parallel tracks on an information layer. The information carrier 11 may be an optical disc having an information layer of a recordable type. Examples of a recordable disc are the CD-R, CD-RW and the DVD+RW. The track 9 on the recordable type of information carrier is indicated by a preembossed track 9 structure provided during manufacture of the blank information carrier 11, for example a pregroove. Recorded information is represented on the information layer by optically detectable marks recorded along the track 9. The marks are constituted by variations of a physical parameter and thereby have different optical properties than their surroundings, e.g. variation in reflection.

FIG. 1b is a cross-section taken along the line b-b of the information carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

In an embodiment the information carrier 11 is carrying information representing digitally encoded video according to a standardized format like MPEG2.

FIG. 1c shows an example of a wobble of the track 9. A detail 12 of the track 9 shows a periodic variation of the lateral position of the pregroove 14, also called wobble. The variations cause an additional signal to arise in auxiliary detectors, e.g. in the push-pull channel generated by partial detectors in the central spot in a head of a scanning device. The wobble is, for example, frequency modulated and position information is encoded in the modulation. A comprehensive description of the wobble and encoding information therein can be found for CD in U.S. Pat. No. 4,901,300 (PHN 12.398) and U.S. Pat. No. 5,187,699 (PHQ 88.002), and for the DVD+RW system in U.S. Pat. No. 6,538,982 (PHN 17.323).

A radiation source such as a semiconductor laser, begins to radiate when the current fed to the radiation source crosses a certain level, called the threshold current Iₜᵣₕ. In FIG. 2 two threshold currents Iₜₕᵣ₋₁ and Iₜₕᵣ₋₂ are depicted. On the vertical axis the radiation power Pᵣ is set out, and on the horizontal axis the current fed to the radiation source is set out. The curve 1 shows the relation between the current fed to the radiation source and the radiation power at a first temperature of the radiation source. The curve 2 shows the relation between the current fed to the radiation source and the radiation power at a second temperature of the radiation source. The threshold current Iₜₕᵣ is dependent on the temperature of the radiation source. The threshold current Iₜₕᵣ₋₁ of curve 1 is smaller than the threshold current Iₜₕᵣ₋₂ of curve 2. Also shown in FIG. 2 is the additional current needed to achieve a certain radiation power Pᵣ₁. In curve 1 the additional current, also called delta current, is I_{delta-1}. However in curve 2 the delta current Iₜₕᵣ₋₂ is greater than Iₜₕᵣ₋₁. This is because the slope of the curve changes as the temperature of the radiation source changes. It seems that there is a relation between the threshold current Iₜₕᵣ and the delta current I_{delta}. This relation is used in a radiation source driving device to predict the delta current I_{delta} which is needed in addition to the threshold current Iₜₕᵣ to achieve the predetermined radiation power Pᵣ₁. When the radiation power Pᵣ can be measured, then this measured radiation power Pᵣ is used as a feedback to control the radiation power. In this case there is no need to predict the delta current I_{delta} from the threshold current Iₜₕᵣ. However, when the radiation source is controlled in such a manner that the radiation power can not be measured, then the relation between the delta current I_{delta} and the threshold current Iₜₕᵣ is used. For instance, a common write strategy is to control the radiation source with short pulses. Since the writing speeds are increasing recently, the pulses become too short to be able to measure the radiation power.

The radiation source driving device uses a function F which is a model for the relation between the threshold current Iₜₕᵣ and the delta current I_{delta} and the radiation power Pᵣ. For instance, the following function is used:

$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a \qquad ( 6 )$$

wherein I_{THR-1} is a first threshold current, I_{THR-2} is a second threshold current, I_{DELTA-1} is a first delta current, I_{DELTA-2} is a second delta current and a is a parameter. The value of ‘a’ depends on the radiation source and can also change during the lifetime of the radiation source. It is difficult to measure this parameter during the factory adjustment, as it takes time to heat up the radiation source sufficiently, moreover the ageing effect can not be accounted for in production. Therefore the parameter a is calibrated during normal operation of the drive.

In FIG. 3 the radiation source 26 is fed with a current Iₜₒₜ. As a result the radiation source 26 radiates. The radiation power is measured by the radiation power measurement means 27. The measured radiation power Pₘ is fed to the threshold current determining means 20 and the delta current determining means 21. The threshold current determining means 20 determines the threshold current Iₜₕᵣ at which the radiation source 26 begins to radiate. the threshold current Iₜₕᵣ is fed to the addition means 25. The delta current generator 21 comprises an online delta current generator which generates an online delta current by using the measured radiation power Pₘ. As can be seen in FIG. 2 as from the threshold current Iₜₕᵣ the radiation power Pᵣ has a linear relation with the delta current I_{delta}. Thus by measuring the radiation power the delta current can be easily calculated by subtracting the measured radiation power Pₘ from the predetermined radiation power Pᵣ₁. The delta current generator 21 further comprises an estimated delta current generator 22 which generates an estimated delta current by using a function F. The function F predicts the delta current I_{delta} needed to achieve the predetermined radiation power Pᵣ₁ with the threshold current Iₜₕᵣ as an input. The delta current outputting means 24 passes either the online delta current to the output or the estimated delta current. The delta current outputting means 24 may have an input coming from a central processing unit of the information reproducing system which input controls the selection of the online delta current and the estimated delta current.

According to the invention the radiation source driving device further comprises calibration means 28. The calibration means 28 can determine for instance the parameter a in function (6) by determining the delta current I_{delta} at two different threshold currents Iₜₕᵣ at a constant predetermined radiation power Pᵣ₁. When the function F comprises more parameters, then more calibration point are needed to determine updated parameters. The parameters of the function F can initially be set to a certain estimated value. However, the parameters are dependent on the radiation source 26 and are usually not a very good estimate. During operation of the radiation source driving device, these parameters are updated to more accurate ones by the calibration means.

In an information reproducing device wherein information can also be recorded on the information carrier 11 the radiation source 26 is driven in a write mode or a read mode. In the read mode the radiation power Pᵣ can usually be measured. In the write mode it is common to control the radiation source 26 with small pulses. Before applying the write pulses a threshold current is fed to the radiation source 26. The threshold current Iₜₕᵣ can be determined during this period. When the pulses are applied to the radiation source 26 the radiation power Pᵣ can not be measured or is difficult to measure. The function F is then used to determine the delta current I_{delta} needed to establish the predetermined radiation power Pᵣ₁. The determined delta current I_{delta-1}, threshold current Iₜₕᵣ₋₁ are stored. The next time the delta current I_{delta-2} and the threshold current Iₜₕᵣ₋₂ are determined and the threshold current Iₜₕᵣ₋₂ is substantially different from the threshold current Iₜₕᵣ₋₁ the calibration means can update the parameters of the function F (provided that the function F only has one parameter).

A special case is when writing to a rewritable optical disc, such as a CD-RW or DVD+RW. The write strategy for that kind of disc is pulsed writing. The instantaneous radiation power cannot be measured during the pulsed writing. However, in between the write pulses an erase block is radiated in order to erase the information on the rewriteable disc. The erase block has a block strategy so that the radiation power during the erase block can be measured. During the write pulse the instantaneous radiation power cannot be measured, but an average radiation power can be measured. If the radiation power during the erase block and the average radiation power during the write pulses would be substantially different from each other, then it would be possible to retrieve the threshold current and the delta current from the measured radiation powers. However, the radiation power during the erase block and the average radiation power during the write pulses are substantially of the same level. In this case the threshold current is determined during the erase block and subsequently used to determine the delta current with the function F.

FIG. 4 shows an information reproducing and/or recording device according to the invention. The device includes rotating means 31 for rotating the information carrier 11, a head 32, a servo unit 35 for positioning the head 32 on the track 9, and a control unit 30. The head includes the radiation source driving device, the radiation source 26, and means 36 for mapping the radiation emitted by the radiation source 25 at a spot 33 at the information carrier 11. The radiation source 26 can be a laser diode. The means 36 can be an optical system of a known type for guiding the radiation beam through optical elements and focus the radiation beam to a radiation spot 33 on a track 9 of the information carrier 11. The head further comprises (not shown) a focusing actuator for moving the focus of the radiation beam along the optical axis of said beam and a tracking actuator for fine positioning of the spot 33 in a radial direction on the center of the track 9. The tracking actuator may comprise coils for radially moving an optical element or may alternatively be arranged for changing the angle of a reflecting element. The focusing and tracking actuators are driven by actuator signals from the servo unit 35. For reading the radiation reflected by the information carrier 11 is detected by a detector of a usual type, e.g. a four-quadrant diode, in the head 32 for generating detector signals coupled to a front-end unit 41 for generating various scanning signals, including a main scanning signal 43 and error signals 45 for tracking and focusing. The error signals 45 are coupled to the servo unit 35 for controlling said tracking and focusing actuators. The main scanning signal 43 is processed by read processing unit 40 of a usual type including a demodulator, deformatter and output unit to retrieve the information.

In an embodiment the device is provided with recording means for recording information on an information carrier 11 or a writable or re-writeable type, for example CR-R or CD-RW, or DVD+RW or BD. The recording means cooperate with the head 32 and front-end unit 41 for generating a write beam of radiation, and comprise write processing means for processing the input information to generate a write signal to drive the head 32, which write processing means comprise an input unit 37, a formatter 38 and a modulator 39. For writing information the beam of radiation is controlled to create optically detectable marks on the information carrier 11. The marks may be in any optically readable form, e.g. in the form of areas with a reflection coefficient different from their surroundings, obtained when recording in materials such as dye, alloy or phase change material. or in the form of areas with a direction of polarization different from their surroundings. obtained when recording in magneto-optical material.

Writing and reading of information for recording on optical disks and formatting, error correcting and channel coding rules are well-known in the art, e.g. from the CD or DVD system. In an embodiment the input unit 37 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The control unit 30 controls the scanning and retrieving of information and may be arranged for receiving commands form a user of from a host computer. The control unit 30 is connected via control lines 42, e.g. a system bus, to the other units in the device. The control unit may provide a signal to the delta current outputting means 24 to select the online delta current or the estimated delta current.

1. Method for controlling radiation power of a radiation source (26), comprising the steps of
a) driving the radiation source (26) in a first mode comprising the substeps of
a1) determining a threshold current (Iₜₕᵣ) at which the radiation source (26) begins to radiate,
a2) measuring the radiation power emitted by the radiation source (26),
a3) driving the radiation source (26) with the threshold current (Iₜₕᵣ) increased with the a delta current (I_{delta}) for obtaining a predetermined radiation power Pᵣ₁, wherein the delta current (I_{delta}) is calculated by subtracting the measured radiation power (Pₘ) from the predetermined radiation power Pᵣ₁,
b) driving the radiation source (26) in a second mode comprising the substeps of
b1) determining the threshold current (Iₜₕᵣ), and
b2) driving the radiation source (26) with the threshold current (Iₜₕᵣ) increased with the delta current (I_{delta}) for obtaining the predetermined radiation power Pᵣ₁, wherein the delta current (I_{delta}) is calculated from the threshold current (Iₜₕᵣ) by using a function F which is a model for the relation between the threshold current (Iₜₕᵣ) and the delta current (I_{delta}) and the radiation power,
characterized in that the method further comprises the step of
c) calibrating the function F, comprising the substeps of
c1) determining the radiation power and the delta current (I_{delta}) at at least two different threshold currents (Iₜₕᵣ) when the radiation source (26) is driven in the first mode, and
c2) updating at least one parameter of the function F by using the measurements in substep c1.

2. Method as claimed in claim 1, characterized in that the first mode is a mode wherein the current (Iₜₒₜ) to the radiation source (26) comprises a pulse which has a duration long enough to measure the radiation power and wherein the second mode is a mode wherein the current (Iₜₒₜ) to the radiation source (26) comprises a train of short pulses.

3. Method as claimed in claim 1, characterized in that the function F is defined by a model describing the change in delta current (I_{delta}) as a function of the change in threshold current (Iₜₕᵣ) at the predetermined radiation power Pᵣ₁:
$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a$$
wherein I_{THR-1} is a first threshold current, I_{THR-2} is a second threshold current, I_{DELTA-1} is a first delta current, I_{DELTA-2} is a second delta current and a is a parameter and wherein the function F is updated by updating the parameter a.

4. Method as claimed in claim 1, characterized in that in
substep c1 the radiation power and delta current (I_{delta}) are measured at more than two threshold currents (Iₜₕᵣ).

5. Method as claimed in claim 4, characterized in that the function F is defined by a model describing the change in delta current (I_{delta}) as a function of the change in threshold current (Iₜₕᵣ) at a predetermined level of the radiation power Pr:
$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a + b$$
wherein I_{THR-1} is a first threshold current, I_{THR-2} is a second threshold current, I_{DELTA-1} is a first delta current, I_{DELTA-2} is a second delta current and a and b are parameters and wherein the function F is updated by updating the parameters a and b.

6. Method as claimed in claim 1, characterized in that the
threshold current (Iₜₕᵣ) is changed by changing the temperature of the radiation source (26).

7. A radiation source driving device for controlling a radiation power of a radiation source (26) in an information reproducing system for reproducing information on an information carrier (11), comprising
radiation power measurement means (27) for measuring a radiation power of the radiation source (26),
addition means (25) for outputting a total current (Iₜₒₜ) by adding a threshold current (Iₜₕᵣ) and a delta current (I_{delta}) and thereby obtaining a predetermined radiation power Pᵣ₁,
threshold current determining means (20) for determining and outputting the threshold current (Iₜₕᵣ) at which the radiation source (26) begins to radiate, wherein the measured radiation power (Pₘ) is used to determine the threshold current (Iₜₕᵣ),
delta current determining means (21) for determining and outputting the delta current (I_{delta}) wherein the value of the delta current (I_{delta}) is determined such that the radiation power is substantially equal to a predetermined radiation power Pᵣ₁, comprising
an online delta current generator (23) for generating an online delta current which is determined by subtracting the measured radiation power (Pₘ) from the predetermined radiation power Pᵣ₁,
an estimated delta current generator (22) for generating an estimated delta current which is calculated from the threshold current (Iₜₕᵣ) by using a function F which is a model for the relation between the threshold current (Iₜₕᵣ) and the delta current (I_{delta}) and the radiation power,
delta current outputting means (24) for outputting the delta current (I_{delta}), wherein the online delta current is outputted when the radiation power is measured and the estimated delta current is outputted when the radiation power is not measured,
characterized in that the radiation source driving device further comprises calibration means (28) for updating at least one parameter of the function F, wherein the delta current (I_{delta}), the threshold current (Iₜₕᵣ) and the measured radiation power (Pₘ) are fed to the calibration means (28) and wherein the radiation power and the delta current (I_{delta}) are determined at at least two different threshold currents (Iₜₕᵣ) and are subsequently used to update the at least one parameter.

8. (canceled)

9. A radiation source driving device as claimed in claim 7, characterized in that the radiation source current generator (21) is able to drive the radiation source (26) in a first mode and in a second mode, wherein the radiation power measurement means (27) are able to measure the radiation power when the radiation source (26) is driven in the first mode and wherein the radiation power measurement means (27) are not able to measure the radiation power when the radiation source (26) is driven in the second mode, wherein the calibration means (28) are arranged to calibrate the function F during a period wherein the radiation source (26) is driven in the first mode.

10. A radiation source driving device as claimed in claim 9, characterized in that the first mode is a mode wherein the current to the radiation source (26) comprises a pulse which has a duration long enough to measure the radiation power and wherein the second mode is a mode wherein the current to the radiation source (26) comprises a train of short pulses.

11. A radiation source driving device as claimed in claim 7, characterized in that the function F is defined by a model describing the change in delta current (I_{delta}) as a function of the change in threshold current (Iₜₕᵣ) at the predetermined radiation power Pᵣ₁:
$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a$$
wherein I_{THR-1} is a first threshold current, I_{THR-2} is a second threshold current, I_{DELTA-1} is a first delta current, I_{DELTA-2} is a second delta current and a is a parameter and wherein the calibration means (28) are arranged to update the function F by updating the parameter a.

12. A radiation source driving device as claimed in claim 7, characterized in that the calibration means (28) are arranged for determining the radiation power and the delta current (I_{delta}) at more than two different threshold (Iₜₕᵣ) currents.

13. A radiation source driving device as claimed in claim 12, characterized in that the function F is defined by a model describing the change in delta current (I_{delta}) as a function of the change in threshold current (Ithr) at a predetermined level of the radiation power Pr:
$$\frac{{I}_{DELTA - 2} - {I}_{DELTA - 1}}{{I}_{DELTA - 1}} = \frac{{I}_{THR - 2} - {I}_{THR - 1}}{{I}_{THR - 1}} * a + b$$
wherein I_{THR-1} is a first threshold current, I_{THR-2} is a second threshold current, I_{DELTA-1} is a first delta current, I_{DELTA-2} is a second delta current and a and b are parameters and wherein the calibration means (28) are arranged to update the function F by updating the parameters a and b.

14. A radiation source driving device as claimed in claim 7, characterized in that the radiation source driving device is arranged to change the threshold current (Iₜₕᵣ) for calibration by changing the temperature of the radiation source (26).

15. Information reproducing device for reproducing information on an information carrier (11) comprising
a radiation source driving device as claimed in claim 7,
a radiation source (26) which is driven by the radiation source driving device,
means (36) for mapping radiation emitted by the radiation source (26) at a spot (33) at the -information carrier (11),
means (31) for causing a relative displacement between the spot and the information carrier (11).
